(19) United States
(12) Patent Application Publication
(10) Pub. No.: US 2026/0162635 A1
(43) Pub. Date: Jun. 11, 2026

(54) INFORMATION PROCESSING DEVICE, ELECTRONIC MUSICAL INSTRUMENT SYSTEM, ELECTRONIC MUSICAL INSTRUMENT, SYLLABLE PROGRESSION CONTROL METHOD, AND STORAGE MEDIUM

(71) Applicant: CASIO COMPUTER CO., LTD., Shibuya-ku, Tokyo (JP)

(72) Inventors: Makoto DANJYO, Tokyo (JP); Fumiaki OTA, Tokyo (JP); Atsushi NAKAMURA, Tokyo (JP)

(73) Assignee: CASIO COMPUTER CO., LTD., Shibuya-ku, Tokyo (JP)

(21) Appl. No.: 18/722,762

(22) PCT Filed: Dec. 13, 2022
(86) PCT No.: PCT/JP2022/045757

§ 371 Date: Jun. 21, 2024

(30) Foreign Application Priority Data
Dec. 22, 2021 (JP) 2021-207713

(51) Int. Cl. G10H 1/00; G10L 13/06

(52) U.S. Cl. CPC G10H 1/0008; G10L 13/06; G10H 2210/076; G10H 2220/221

(57) ABSTRACT

An information processing device includes a processor which performs: detecting an operation on a second operation element after a set time has elapsed from a detection of an operation on a first operation element, detecting a number of an operation element that is in ongoing operation at a timing when the operation on the second operation element is detected, and controlling whether or not to advance a syllable to be sounded from a first syllable to a second syllable, which is a next syllable, based only on the number of the operation element that is in ongoing operation.

### TECHNICAL FIELD

The present invention relates to an information processing device, an electronic musical instrument system, an electronic musical instrument, a syllable progression control method, and a program.

### BACKGROUND ART

In recent years, the use of synthetic voices has been expanding. Under such circumstances, it is desirable to have an electronic musical instrument that can progress lyrics in response to the user's (performer's) key pressing operation and output synthetic voice corresponding to the lyrics, in addition to automatic performance, to enable more flexible expression of synthetic voice.

For example, in Patent Document 1, a technique is disclosed in which lyrics are advanced in synchronization with a performance based on user operation using a keyboard Or the like.

### CITATION LIST

### Patent Literature

Patent Document 1: JP 4735544B

### SUMMARY OF INVENTION

### Technical Problem

In harmony, such as in a chorus group, the melody parts, such as sopranos, often maintain their vowels without changing pitch, while only the alto and bass parts change pitch in melisma, but such harmonic changes cannot be reproduced if the lyric syllables are progressed with each key press.

A purpose of the present invention, made in view of the above problem, is to properly control syllable progression when reproducing harmony, such as in a chorus group, based on the operation of electronic musical instruments.

### Solution to Problem

To solve the above problem, the information processing device of the present invention includes a controller that controls whether or not to advance a syllable to be sounded from a first syllable to a second syllable, which is a next syllable, according to a number of an operation element that is in ongoing operation at a timing when an operation on a second operation element is detected, in response to detection of the operation on the second operation element after a set time has elapsed from detection of an operation on a first operation element.

### Advantageous Effects of Invention

According to the present invention, it is possible to properly control syllable progression when reproducing harmony, such as in a chorus group, based on the operation of electronic musical instruments.

### BRIEF DESCRIPTION OF DRAWINGS

FIG. 1 This is a diagram showing an example of the overall configuration of an electronic musical instrument system of the present invention.

FIG. 2 This is a diagram showing the appearance of the electronic musical instrument shown in FIG. 1.

FIG. 3 This is a block diagram showing the functional configuration of the electronic musical instrument shown in FIG. 1.

FIG. 4 This is a block diagram showing the functional configuration of a terminal device shown in FIG. 1.

FIG. 5 This is a diagram showing the configuration pertaining to sounding of singing voices in response to keyboard key pressing operations in a singing voice sounding mode of the electronic musical instrument shown in FIG. 1.

FIG. 6 This is an imaginary diagram showing the relationship between frames and syllables.

FIG. 7 This is a flowchart showing the flow of a sounding control process executed by the CPU in FIG. 3.

FIG. 8 This is a flowchart showing the flow of a syllable progression control process executed by the CPU in FIG. 3.

FIG. 9 This is a diagram showing an example of syllable progression by the syllable progression control process of FIG. 8.

### DESCRIPTION OF EMBODIMENTS

The embodiments for carrying out the present invention are described below with drawings. However, the embodiments described below are subject to various technically preferred limitations for implementing the present invention. Therefore, the technical scope of the present invention is not limited to the following embodiments and illustrated examples.

### Configuration of Electronic Musical Instrument System 1

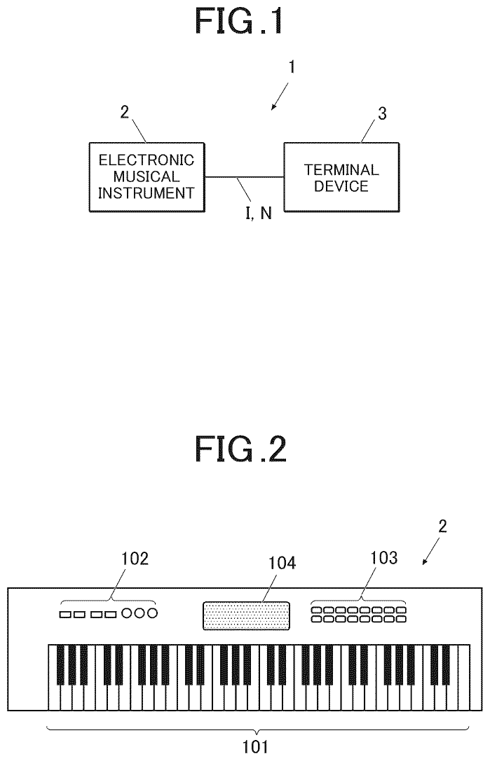

FIG. 1 is a diagram showing an example of the overall configuration of the electronic musical instrument system 1 according to the present invention.

As shown in FIG. 1, the electronic musical instrument system 1 consists of an electronic musical instrument 2 and a terminal device 3, connected via a communication interface I (or communication network N).

### Configuration of Electronic Musical Instrument 2

In addition to the normal mode, in which the electronic musical instrument 2 outputs instrumental sounds in response to the user's key pressing operations to a keyboard 101, the electronic musical instrument 2 also has a singing voice sounding mode, in which singing voices are sounded in response to key pressing operations to the keyboard 101, enabling polyphonic sounding of harmony consisting of multiple parts, such as a chorus group.

FIG. 2 is a diagram showing an example of the appearance of an electronic musical instrument 2. The electronic musical instrument 2 includes a keyboard 101 including multiple keys as operation elements, a first switch panel 102 and a second switch panel 103 for instructing various settings, and an LCD 104 (Liquid Crystal Display) for various displays. The electronic musical instrument 2 also includes a speaker 214 that emits musical sounds and voices (singing voices) generated by performance, on the back, side, rear portions, or the like.

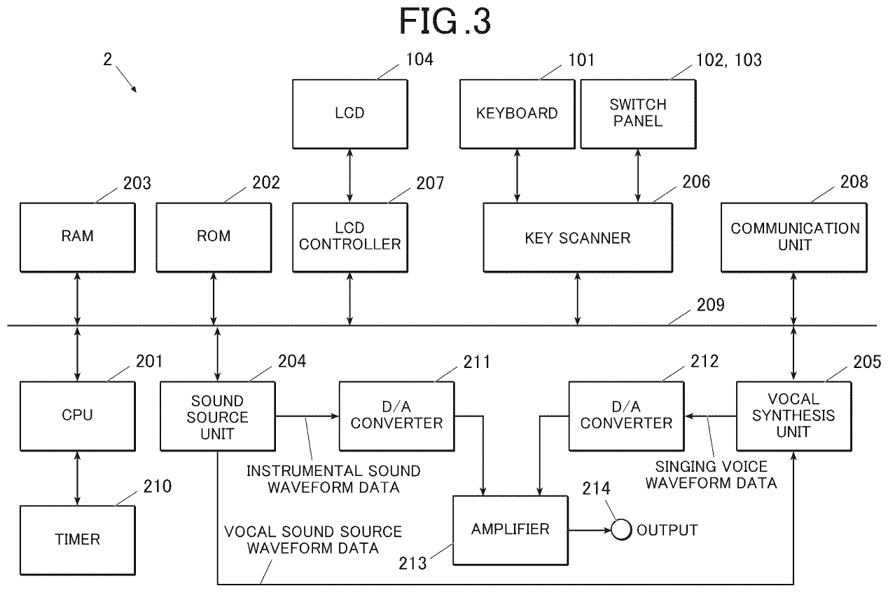

FIG. 3 is a block diagram showing the functional configuration of the control system of the electronic musical instrument 2 of FIG. 1. As shown in FIG. 3, the electronic musical instrument 2 has a CPU (Central Processing Unit) 201 connected to a timer 210, a ROM (Read Only Memory) 202, a RAM (Random Access Memory) 203, a sound source unit 204, a vocal synthesis unit 205, a key scanner 206 to which the keyboard 101, the first switch panel 102, and the second switch panel 103 of FIG. 2 are connected, an LCD controller 207 to which the LCD 104 of FIG. 2 is connected, and a communication unit 208, which are each connected to the bus 209. In the present embodiment, the first switch panel 102 includes a singing voice sounding mode switch described below. The second switch panel 103 includes a tone setting switch described below.

The sound source unit 204 and vocal synthesis unit 205 are connected to D/A converters 211 and 212, respectively, and the waveform data of instrumental sounds output from the sound source unit 204 and the voice waveform data of singing voices (singing voice waveform data) output from the vocal synthesis unit 205 are converted into analog signals by the D/A converters 211 and 212, respectively, amplified by the amplifier 213, and thereafter output from the speaker 214.

The CPU 201 executes the control operation of the electronic musical instrument 2 of FIG. 1 by executing the program stored in the ROM 202 while using the RAM 203 as a work memory. The CPU 201, in cooperation with the program stored in the ROM 202, performs a sounding control process and a syllable progression control process described below, thereby realizing the functions of the controller of the information processing device of the present invention.

The ROM 202 stores programs, various fixed data, and the like,

The sound source unit 204 has a waveform ROM that stores waveform data for instrumental sounds (instrumental sound waveform data) such as piano, organ, synthesizer, stringed instrument, and wind instrument, as well as waveform data of various tones such as human voice, dog voice, and cat voice as waveform data for vocal sound sources in the singing voice sounding mode (vocal sound source waveform data). The instrumental sound waveform data can also be used as vocal sound source waveform data.

In the normal mode, the sound source unit 204 reads instrumental sound waveform data from the waveform ROM not shown, for example, based on the pitch information of the pressed key of the keyboard 101, in accordance with the control instruction from the CPU 201, and outputs the data to the D/A converter 211. In the singing voice sounding mode, the sound source unit 204 reads waveform data from the waveform ROM not shown, for example, based on the pitch information of the pressed key of the keyboard 101, in accordance with the control instruction from the CPU 201, and outputs it as vocal sound source waveform data to the vocal synthesis unit 205. The sound source unit 204 can output waveform data for multiple channels simultaneously. Based on the pitch information and the waveform data stored in the waveform ROM, the waveform data may be generated according to the pitch of the key pressed on the keyboard 101.

The sound source unit 204 is not limited to the PCM (Pulse Code Modulation) sound source method, but may also use other sound source methods, for example, FM (Frequency Modulation) sound source method.

The vocal synthesis unit 205 has a synthesis filter 205a and generates singing voice waveform data based on singing voice parameters given by the CPU 201 and the vocal sound source waveform data input from the sound source unit 204, and outputs it to the D/A converter 212,

The sound source unit 204 and the vocal synthesis unit 205 may be configured by dedicated hardware such as LSI (Large-Scale Integration):, or they may be realized by software by cooperation of the program stored in the ROM 202 and the CPU 201.

The key scanner 206 routinely scans the pressed/released state of each key of the keyboard 101 in FIG. 2, and the switch operation state of the first switch panel 102 and the second switch panel 103, and outputs the pitch and pressed/released key information (performance operation information) Of the operated key and switch operation information to the CPU 201.

The LCD controller 207 is an IC (integrated circuit) that controls the display state of the LCD 104.

The communication unit 208 sends and receives data to and from external devices such as the terminal device 3, which is connected via the communication interface I such as a communication network N such as the Internet or a USB (Universal Serial Bus) cable.

### Configuration of Terminal Device 3

FIG. is a block diagram showing the functional configuration of the terminal device 3 in FIG. 1.

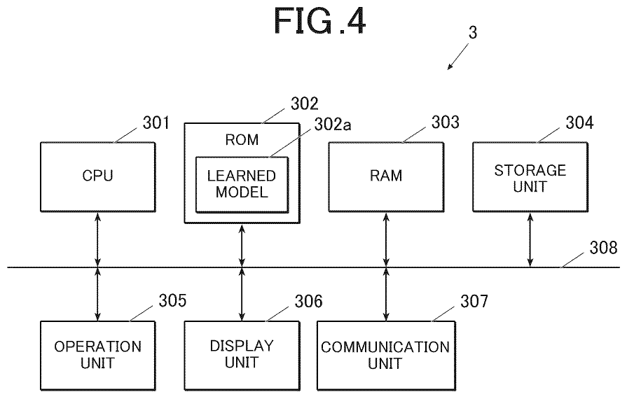

As shown in FIG. 4, the terminal device 3 is a computer including a CPU 301, a ROM 302, a RAM 303, a storage unit 304, an operation unit 305, a display unit 306, a communication unit 307, and the like, and each part is connected by bus 308. For example, a tablet PC (Personal Computer), a notebook PC, a smart phone, and the like are applicable as the terminal device 3.

The ROM 302 of. the terminal device 3 has a learned model 302a. The learned model 302a is generated by machine learning multiple data sets including musical score data (lyric data (lyric text information) and pitch data (including sound length information) ) of multiple sung songs and singing voice waveform data of a singer singing respective sung songs. When lyric data and pitch data of any sung song (or phrase) are input, the learned model 302a infers a group of singing voice parameters (called singing voice information) for sounding a singing voice equivalent to the singing voice singing the input sung song by the singer at the time the learned model 302a was generated.

### Operation of Singing Voice Sounding Mode

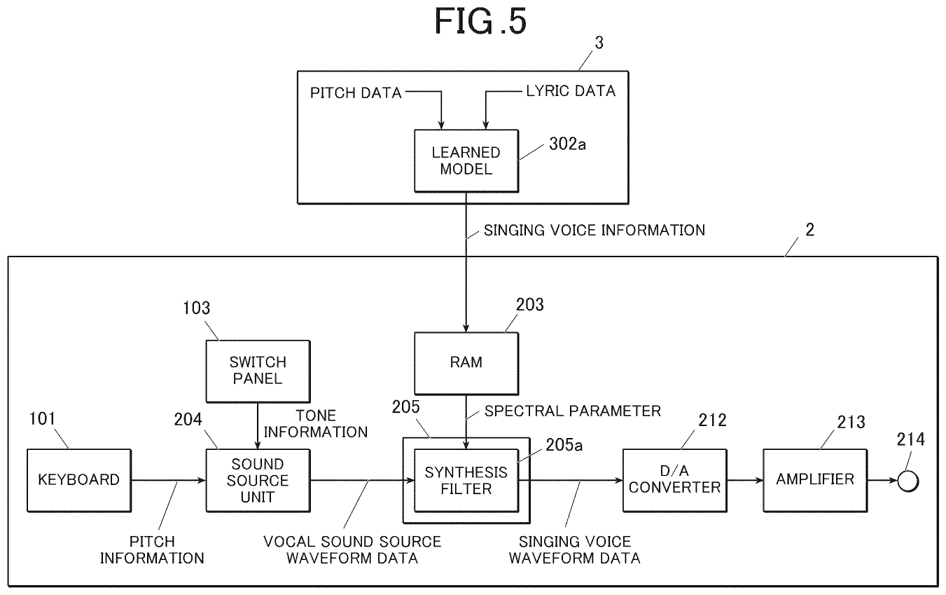

FIG. 5 shows the configuration pertaining to the sounding of singing voice in response to the key pressing operation on the keyboard 101 in the singing voice sounding mode. Referring to FIG. 5, the operation of the electronic musical instrument 2 when sounding singing voice in response to the key pressing operation on the keyboard 101 in the singing voice sounding mode will be described below.

If the user wishes to perform in the singing voice sounding mode, the user presses the singing voice sounding mode switch on the first switch panel 102 in the electronic musical instrument 2 to instruct to shift the operation mode to the singing voice sounding mode.

When the singing voice sounding mode switch is pressed, the CPU 201 shifts the operation mode to the singing voice sounding mode. When the user selects the tone of the voice to be sounded using the tone selection switch on the second switch panel 103, the CPU 201 sets the information of the selected tone to the sound source unit 204.

Next, the user inputs the lyric data and pitch data of any sung song that he/she wants the electronic musical instrument 2 to sound in the singing voice sounding mode on the terminal device 3 using a dedicated application or the like. The lyric data and pitch data of sung songs may be stored in the storage unit 304, and the lyric data and pitch data of any sung song may be selected from the data stored in the storage unit 304.

When lyric data and pitch data of any sung song to be sounded in the singing voice sounding mode are input at the terminal device 3, the CPU 301 inputs the input lyric data and pitch data of the sung song to the learned model 302a, causes the learned model 302a to infer a group of singing voice parameters, and sends singing voice information which is the inferred group of singing voice parameters to the electronic musical instrument 2 by the communication unit 307.

Here is an explanation of the singing voice information.

Each section of sung song separated by a predetermined time unit in the time direction is called a frame, and the learned model 302a generates singing voice parameters in frame units. In other words, the singing voice information of one sung song is composed of multiple singing voice parameters (group of singing voice parameters) in frame units. In the present: embodiment, one frame is defined as the length of one sample×225 when the sung song is sampled at a predetermined sampling frequency (for example, 44.1 kHz).

The singing voice parameters in frame units include a spectral parameter (frequency spectrum of the voice to be sounded) and a fundamental frequency FO parameter (pitch frequency of the voice to be sounded).

The singing voice parameters in frame units also include information on syllables.

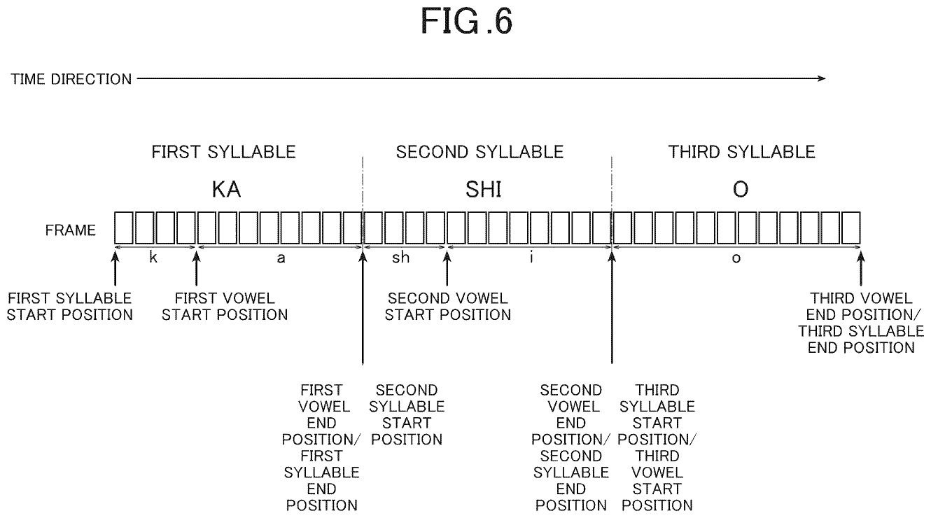

FIG. 6 is an image showing the relationship between frames and syllables (FIG. 6 does not use the registered trademark). As shown in FIG. 6, the voice of a sung song is composed of multiple syllables (first to third syllables in FIG. 6). Each syllable is generally composed of one vowel or a combination of one vowel and one or more consonants. Each syllable is sounded over multiple consecutive frame sections in the time direction, and the syllable start position, syllable end position, vowel start position, and vowel end position (all in the time direction) of each syllable in a sung song can be identified by the frame position (the number of the frame from the beginning). The singing parameters for the frame corresponding to the syllable start position, syllable end position, vowel start position, and vowel end position of each syllable in the singing voice information include information such as the O-th syllable start frame, O-th syllable end frame, O-th vowel start frame, and O-th vowel end frame (O is a natural number).

Returning to FIG. 5, in the electronic musical instrument 2, when the singing voice information is received from the terminal device 3 by the communication unit 208, the CPU 201 stores the received singing voice information in the RAM 203.

When the user operates the keyboard 101 and performance operation information is input from the key scanner 206, the CPU 201 inputs the pitch information of the pressed key to the sound source unit 204. The sound source unit 204 reads the waveform data corresponding to the input pitch information of the preset tone from the waveform ROM as vocal sound source waveform data and inputs it to the synthesis filter 205a of the vocal synthesis unit 205.

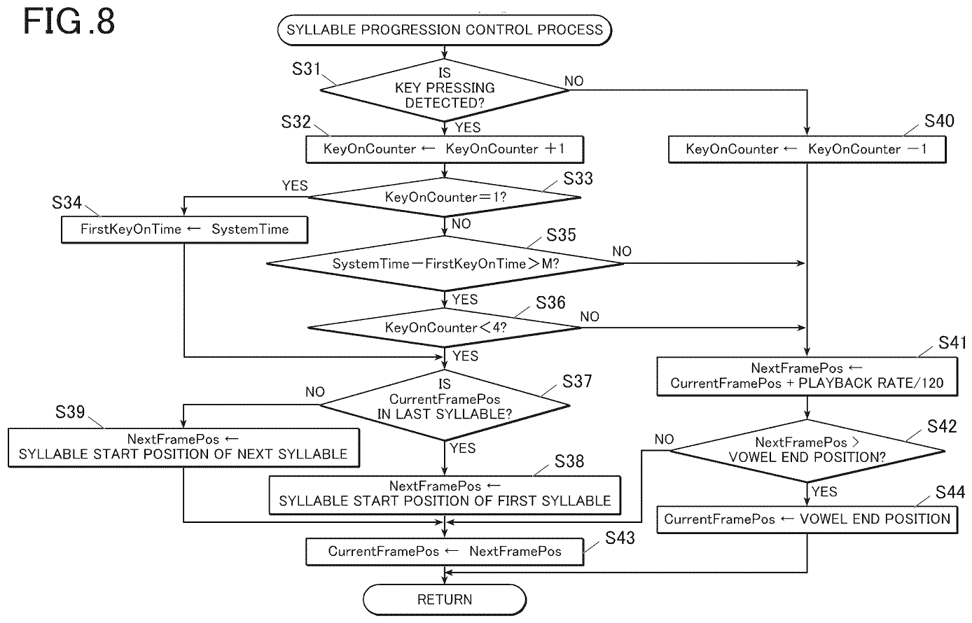

When performance operation information is input from the key scanner 206, the CPU 201 identifies the frame to be sounded in response to the performance operation by executing the syllable progression control process (see FIG. 8) described below, and reads the spectral parameter of the identified frame from the RAM 203 and inputs it to the synthesis filter 205a.

The synthesis filter 205a generates singing voice waveform data based on the input spectral parameter and the vocal sound source waveform data, and outputs it to the D/A converter 212. The singing voice waveform data output to the D/A converter 212 is converted to an analog voice signal, amplified by the amplifier 213 and output from the speaker 214.

Here, in harmony, such as in a chorus group, the melody parts, such as soprano, often maintain their vowels without changing pitch, while only the alto and bass parts change pitch in melisma. However, such harmonic changes cannot be reproduced if the lyric syllable is progressed with each key press.

Therefore, in the singing voice sounding mode, the CPU 201 controls such that the syllable progression is appropriate when reproducing harmony such as in a chorus group, by executing the sounding control process including the syllable progression control process shown in FIG. 8 in response to the input of. the performance operation information from the key scanner 206.

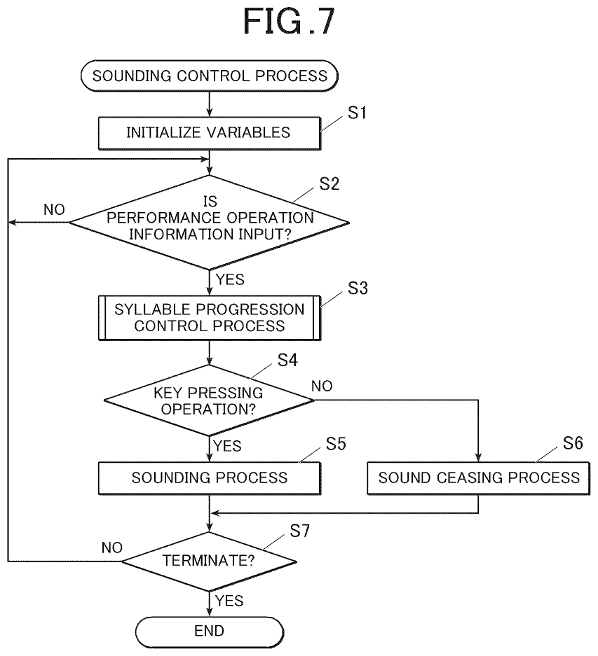

FIG. 7 is a flowchart showing the flow of the sounding control process. The sounding control process is executed by cooperation between the CPU 201 and the program stored in the ROM 202, for example, when singing voice information received from the terminal device 3 by the communication unit 208 is stored in the RAM 203.

First, the CPU 201 initializes the variables used in the syllable progression control process (step S1).

Next, the CPU 201 determines whether or not performance operation information is input by the key scanner 206 (step S2).

If it is determined that performance operation information has been input (step S2; YES) , the CPU 201 executes the syllable progression control process (step S3).

FIG. 8 is a flowchart showing the flow of the syllable progression control process. The syllable progression control process is executed by the cooperation of the CPU 201 and the program stored in ROM 202.

In the syllable progression control process, the CPU 201 detects a key pressing or key releasing operation based on the performance operation information input from the key scanner 206 (step S31).

If a key pressing operation is detected (step S31; YES), the CPU 201 sets KeyOnCounter to KeyOnCounter+1 (step S32).

Here, KeyOnCounter is a variable that stores the number of keys that are currently pressed (being pressed) (number of operation elements in ongoing operation).

Next, the CPU 201 determines whether KeyOnCounter is 1 or not (step S33).

In other words, the CPU 201 determines whether or not the detected key pressing operation was performed in a state in which no other operation elements were pressed.

If KeyOnCounter is determined to be 1 (step S33; YES), the CPU 201 obtains SystemTime (system time), sets FirstKeyOnTime to the obtained SystemTime (step S34), and moves to step S37.

Here, FirstKeyOnTime is a variable that stores the time when the first pressed key (first operation element) among the keys currently pressed is pressed. In other words, when the CPU 201 determines that KeyOnCounter is 1, the CPU 201 judges that an operation on the first operation element (called the first key press) has been detected and sets FirstKeyOnTime.

If it is determined that KeyOnCounter is not 1 (step S33; NO), the CPU 201 obtains SystemTime and determines whether SystemTime−FirstKeyOnTime>M is satisfied (step S35).

Here, M is the simultaneous judgment period (about several milliseconds, corresponding to the set time of the present invention) set in advance to determine whether the detected key pressing operation (operation on the second operation element) was operated at about the same time as the first key press. If SystemTime−FirstKeyOnTime>M is not satisfied (that is, if the time elapsed from the first key press is within the simultaneous judgement period), the detected key pressing operation is considered to be a simultaneous key press with the first key press. If SystemTime−FirstKeyOnTime>M is satisfied (that is, the time elapsed from the first key press is outside the simultaneous judgement period), the detected key pressing operation is not considered to be a simultaneous key press with the first key press.

If it is determined that SystemTime−FirstKeyOnTime>M is not satisfied (within the simultaneous judgement period) (step S35; NO), the CPU 201 moves to step S41.

Here, the key press for which the judgment in step S35 is NO is simultaneous key press with the first key press. In the case of multiple simultaneous key presses, control is performed so that one syllable advances as a whole including the first key press. In the present embodiment, since the syllable is advanced by the first key press, control is performed to move to step S41, and not to advance the syllable for the other key presses that are the simultaneous key presses,

If it is determined that SystemTime−FirstKeyOnTime>M is satisfied (outside the simultaneous judgement period) (step S35; YES), the CPU 201 determines whether KeyOnCounter<4 is satisfied, that is, whether the number of keys currently being pressed is less than 4 (step S36).

Here, the set number to be compared with KeyOnCounter in step S36 (4 in this case) is the number of parts to be sounded in the singing voice sounding mode. In the present embodiment, the set number to be compared with KeyOnCounter in step S36 is 4, assuming that 4 parts (soprano, alto, tenor, and bass) are to be sounded in the singing voice sounding mode. This set number can be changed according to user operation.

If it is determined that KeyOnCounter<4 is satisfied (step S36; YES), that is, the number of keys currently pressed is less than the number of parts, the CPU 201 moves to step S37.

If it is determined that KeyOnCounter<4 is not satisfied (step S36; NO), that is, the number of keys currently pressed has reached the number of parts, the CPU 201 moves to step S41.

In step S37, the CPU 201 determines whether CurrentFramePos is the frame position of the last syllable (step S37).

This CurrentFramePos is a variable that stores the frame position of the current sounding target frame, and until it is replaced by the frame position of the next sounding target frame in step S43 or S44, the frame position of the previously sounded frame is stored.

If CurrentFramePos is determined to be the frame position of the last syllable (step S37; YES), the CPU 201 sets the syllable start position of the first syllable as NextFramePos, a variable that stores the frame position of the next sounding target frame (step S38), and moves to step S43.

If it is determined that CurrentFramePos is not the frame position of the last syllable (step S37; NO), the CPU 201 sets the syllable start position of the next syllable as NextFramePos (step S39) and moves to step S43.

In step S43, the CPU 201 sets CurrentFramePos to NextFramePos (step S43) and moves to step S4 in FIG. 7.

That is, if the previously sounded frame is not the last syllable, the position of the sounding target frame progresses to the syllable start position of the next syllable. If the previously sounded frame is the last syllable, the position of the sounding target frame progresses to the frame at the first syllable start position since there is no next syllable after the previously sounded syllable.

On the other hand, if it is determined in step S31 that key releasing is detected (step S31; NO), the CPU 201 sets KeyOnCounter to KeyOnCounter−1 (step S40) and moves to step S41.

In step S41, the CPU 201 sets NextFramePos to CurrentFramePos+playback rate/120 (step S41).

Here, 120 is the default tempo value, but is not limited to this. The playback rate is a value set in advance by the user. For example, if the playback rate is set to 240, the position of the next frame to be sounded is set to two positions forward from the current frame position. If the playback rate is set to 60, the position of the next frame to be sounded is set to 0.5 position forward from the current frame position.

Next, the CPU 201 determines whether NextFramePos>vowel end position is satisfied (step S42). In other words, the CPU 201 determines whether the position Of the next frame to be sounded exceeds the vowel end position of the current sounding target syllable (that is, the vowel end position of the previously sounded syllable).

If it is determined that NextFramePos>vowel end position is not satisfied (step S42; NO), the CPU 201 moves to step S43, sets CurrentFramePos to NextFramePos (step S43), and moves to step S4 in FIG. 7. In other words, the frame position of the sounding target frame is advanced to NextFramePos, but NextFramePos is before the vowel end position of the previously sounded syllable. Thus, the frame position of the sounding target frame does not advance to the next syllable.

If it is determined that NextFramePos>vowel end position is satisfied (step S42; YES), the CPU 201 sets CurrentFramePos to the vowel end position of the current sounding target syllable (step S44) and moves to step S4 in FIG. 7. In other words, the frame position of the sounding target frame is set to the vowel end position of the previously sounded syllable, and thus does not advance to the next syllable.

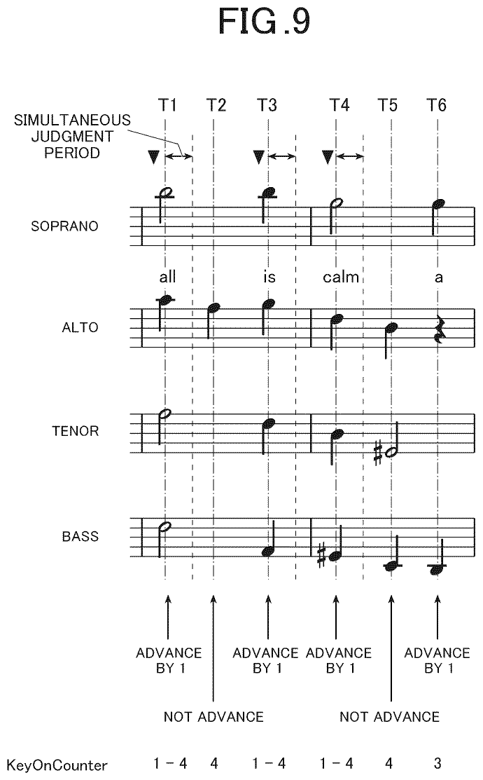

FIG. 9 schematically illustrates the syllable control by the syllable progression control process described above. In FIG. 9, the black inverted triangle indicates the timing when all keys have been released. The KeyOnCounter numerical values indicate the KeyOnCounter values at respective timings from T1 to T6.

The key press at the timing T1 in the performance shown in FIG. 9 is a simultaneous key press of four parts, and thus the syllable is advanced by one. The key press at the timing T2 is a key press outside the simultaneous judgment period, and the number of keys pressed at this timing has reached the number of parts (4). Thus, the syllable is not advanced. The key press at the timing T3 is a simultaneous key press of four parts, and thus the syllable is advanced by one. The key press at the timing T4 is a simultaneous key press of four parts, and thus the syllable is advanced by one. The key press at the timing T5 is a key press outside the simultaneous judgment period, and the number of keys pressed at this timing has reached the number of parts (4). Thus, the syllable is not advanced. The key press at the timing T6 is a key press outside the simultaneous judgment period, and the number of keys simultaneously pressed at this timing is less than the number of parts (4). Thus, the syllable is advanced by one.

Thus, according to the syllable progression control process described above, even when a key pressing operation is detected, if it is a key press outside the simultaneous judgment period (that is, not a first key press or a key press simultaneous with the first key press) and the number of keys pressed at the time of this key pressing operation reaches the number of parts, the syllable to be sounded does not progress to the next syllable. Thus, when the melody part (soprano) remains unchanged in pitch and maintains the vowel, but only the alto or bass part changes pitch in melisma, the syllable of the lyrics can be kept from progressing, and syllable progression can be properly controlled when reproducing harmony.

In step S4 of FIG. 7, the CPU 201 determines whether the operation detected based on the performance operation information input in step S1 is a key pressing operation (step S4).

If the detected operation is determined to be a key pressing operation (step S4; YES), the CPU 201 executes a sounding process to sound the frame at the frame position stored in CurrentFramePos (step S5) and moves to step S7.

In step S5, the CPU 201 causes the vocal synthesis unit 205 to synthesize and output sound of a singing voice based on the pitch information of the key for which the key pressing operation was detected and the spectral parameter of the frame at the frame position stored in the CurrentFramePos.

Specifically, the CPU 201 inputs the pitch information of the key pressed and the key being pressed on the keyboard 101 to the sound source unit 204, and causes the sound source unit 204 to read from the waveform ROM the waveform data corresponding to the input pitch information for the preset tone and input the read data to the synthesis filter 205a of the vocal synthesis unit 205 as vocal sound source waveform data. The CPU 201 also acquires the spectral parameter of the frame at the frame position stored in CurrentFramePos from the singing voice information stored in the RAM 203 and inputs the acquired parameter to the synthesis filter 205a. The synthesis filter 205a generates singing voice waveform data based on the input spectral parameter and vocal sound source waveform data, converts the generated singing voice waveform data into an analog voice signal by the D/A converter 212, and outputs (sounds) the converted signal via the amplifier 213 and the speaker 214.

If the detected operation is determined to be a key releasing operation (step S4; NO), the CPU 201 executes a sound ceasing process of the voice for the released key (step S6) and moves to step S7.

In step S7, the CPU 201 causes the sound of the singing voice to be synthesized and output based on the pitch information of the key currently being pressed, other than the key that was released, and the spectral parameter of the frame at the frame position stored in CurrentFramePos.

Specifically, the CPU 201 inputs the pitch information of the key currently pressed, other than the key that was released, to the sound source unit 204, and causes the sound source unit 204 to input the waveform data corresponding to the input pitch information, for a preset tone, as the vocal sound source waveform data to the synthesis filter 205a of the vocal synthesis unit 205. The CPU 201 also acquires the spectral parameter of the frame at the frame position stored in CurrentFramePos from the singing voice information stored in the RAM 203 and inputs it to the synthesis filter 205a. The synthesis filter 205a generates singing voice waveform data based on the input spectral parameter and vocal sound source waveform data, converts the generated singing voice waveform data into an analog voice signal by the D/A converter 212, and outputs (sounds) it via the amplifier 213 and the speaker 214.

In step S7, the CPU 201 determines whether or not termination of the singing voice sounding mode is instructed (step S7).

For example, if the singing voice sounding mode switch is pressed during the singing voice sounding mode, the CPU 201 judges that the termination of the singing voice sounding mode is instructed.

If it is determined that the termination of the singing voice sounding mode is not instructed (step S7; NO), the CPU 201 returns to step S2.

If it is determined that the termination of the singing voice sounding mode is instructed (step S7; YES), the CPU 201 terminates the singing voice sounding mode.

As explained above, according to the CPU 201 of electronic musical instrument 2, when a key pressing operation is detected after the elapse of the simultaneous judgment period, depending on the number of operation elements that are in ongoing operation at the timing when the key pressing operation is detected, the CPU 201 controls whether the syllable to be sounded is advanced from the first syllable (not limited to the syllable at the head) to the next second syllable or not.

For example, the CPU 201 controls not to advance from the first syllable to the second syllable when the number of operation elements in ongoing operation has reached the set number, and controls to advance from the first syllable to the second syllable when the number of operation elements in ongoing operation is less than the set number.

Thus, for example, when the melody part does not change pitch and maintains the vowel, but only the alto or bass parts change pitch in melisma, the syllable of the lyrics can be kept from progressing, and syllable progression can be properly controlled when reproducing harmony.

The CPU 201 controls the syllable corresponding to the voice to be sounded to be advanced from the first syllable to the second syllable when there is no operation element in ongoing operation at the detected timing. Thus, syllable progression can be controlled appropriately.

The CPU 201 starts counting the simultaneous judgment period when it detects an operation on any of the operation elements while no operation on any of the operation elements is being performed. Thus, syllable progression can be properly controlled.

The description in the above embodiment is a suitable example of the information processing device, the electronic musical instrument, the syllable progression control method and the program according to the present invention, and the present invention is not limited to this.

For example, in the above embodiment, the information processing device of the present invention is described as a configuration included in the electronic musical instrument 2, but the present invention is not limited to this. For example, the functions of the information processing device of the present invention may be included in an external device (for example, the terminal device 3 (a PC (Personal Computer), tablet terminal, smartphone, or the like) described above) connected to the electronic musical instrument 2 via a wired or wireless communication interface. In this case, the information processing device sends the parameter (in this case, the spectral parameter) in accordance with the syllable position control to the electronic musical instrument 2, and the electronic musical instrument 2 sounds the synthesized voice based on the received parameters.

In the above embodiment, the learned model 302a is described as being included in the terminal device 3, but it may also be configured to be included in the electronic musical instrument 2. The learned model 302a may then infer singing voice information based on lyric data and pitch data input in the electronic musical instrument 2.

In the above embodiment, the description is made by taking, as an example, the case where the electronic musical instrument 2 is an electronic keyboard instrument, but the electronic musical instrument 2 is not limited to this and can be other electronic musical instruments such as electronic string instruments and electronic wind instruments, for example.

Although the above embodiment discloses an example of using a semiconductor memory such as ROM or a hard disk as a computer-readable medium for the program of the present invention, the medium is not limited to this example. As other computer-readable media, SSDs and portable recording media such as CD-ROMs can be applied. Carrier wave (carrier wave) is also applicable as a medium for providing data of the program for the present invention via communication lines.

Other detailed configurations and detailed operations of the electronic musical instrument, the information processing device, and the electronic musical instrument system can be changed as needed within the range not departing from the gist of the invention.

Although the embodiments of the present invention have been described above, the technical scope of the present invention is not limited to the embodiments described above, but is defined based on the description of the claims. Furthermore, the technical scope of the present invention includes the equal scope having changes made from the description of the claims, the changes having nothing to do with the essence of the present invention.

The entire disclosure of Japanese Patent Application No. 2021-207713, filed on Dec. 22, 2021, including description, claims, drawings and abstract is incorporated herein by reference.

### INDUSTRIAL APPLICABILITY

The present invention relates to control of electronic musical instruments, and has industrial applicability.

### REFERENCE SIGNS LIST

1 electronic musical instrument system
2 electronic musical instrument
101 keyboard
102 first switch panel
103 second switch panel
104 LCD
201 CPU
202 ROM
203 RAM
204 sound source unit
205 vocal synthesis unit
205a synthesis filter
206 key scanner
208 communication unit
209 bus
210 timer
211 D/A converter
212 D/A converter
213 amplifier
214 speaker
3 terminal device
301 CPU
302 ROM
302a learned model
303 RAM
304 storage unit
305 operation unit
306 display unit
307 communication unit
308 bus

1. An information processing device comprising a processor which performs operations comprising:
detecting an operation on a second operation element after a set time has elapsed from a detection of an operation on a first operation element,
detecting a number of an operation element that is in ongoing operation at a timing when the operation on the second operation element is detected, and
controlling whether or not to advance a syllable to be sounded from a first syllable to a second syllable, which is a next syllable, based only on the number of the operation element that is in ongoing operation.

2. The information processing device according to claim 1, wherein each syllable to be sounded includes multiple frames to be sounded one after another, and
wherein the operations performed by the processor further comprise:
determining whether a next frame position to be sounded, which is calculated in accordance with a playback rate, exceeds a vowel end position of the first syllable which is a current sounding target, in response to the number of the operation element that is in ongoing operation reaching a set number,
controlling not to advance from the first syllable to the second syllable by setting the vowel end position as a frame position to be sounded, in response to the next frame position to be sounded exceeding the vowel end position of the first syllable,
controlling not to advance from the first syllable to the second syllable by sounding from the next frame position to be sounded, in response to the next frame position to be sounded not exceeding the vowel end position of the first syllable, and
controlling to advance from the first syllable to the second syllable in response to the number of the operation element that is in ongoing operation not reaching the set number.

3. The information processing device according to claim 1, wherein the processor controls to advance a syllable corresponding to a voice to be sounded from the first syllable to the second syllable in response to absence of the operation element that is in the ongoing operation at the timing of detection.

4. The information processing device according to claim 1, wherein, in response to detection of an operation on any operation element in a state in which no operation element is operated, the processor determines that the operation on the first operation element is detected and starts counting the set time.

5. An electronic musical instrument system comprising:
the information processing device according to claim 1; and
an electronic musical instrument,
wherein:
the information processing device sends a parameter corresponding to syllable position control to the electronic musical instrument, and
the electronic musical instrument sounds a voice synthesized based on the parameter that is received.

6. An electronic musical instrument comprising:
the information processing device according to claim 1; and
multiple operation elements.

7. A method comprising:
detecting, by a processor, an operation on a second operation element after a set time has elapsed from a detection of an operation on a first operation element;
detecting, by the processor, a number of an operation element that is in ongoing operation at a timing when the operation on the second operation element is detected; and
controlling, by the processor, whether or not to advance a syllable to be sounded from a first syllable to a second syllable, which is a next syllable, based only on the number of the operation element that is in ongoing operation.

8. (canceled)

9. The method according to claim 7, wherein each of the syllable to be sounded includes multiple frames to be sounded one after another, and
wherein the method further comprises:
determining, by the processor, whether a next frame position to be sounded, which is calculated in accordance with a playback rate, exceeds a vowel end position of the first syllable which is a current sounding target, in response to the number of the operation element that is in ongoing operation reaching a set number,
controlling, by the processor, not to advance from the first syllable to the second syllable by setting the vowel end position as a frame position to be sounded, in response to the next frame position to be sounded exceeding the vowel end position of
controlling, by the processor, not to advance from the first syllable to the second syllable by sounding from the next frame position to be sounded, in response to the next frame position to be sounded not exceeding the vowel end position of the first syllable, and
controlling, by the processor, to advance from the first syllable to the second syllable in response to the number of the operation element that is in ongoing operation not reaching the set number.

10. The method according to claim 7, wherein the processor controls to advance a syllable corresponding to a voice to be sounded from the first syllable to the second syllable in response to absence of the operation element that is in the ongoing operation at the timing of detection.

11. The method according to claim 7, wherein, in response to detection of an operation on any operation element in a state in which no operation element is operated, the processor determines that the operation on the first operation element is detected and starts counting the set time.

12. A non-transitory computer readable storage medium storing a program executable to cause a processor of an information processing device to execute operations comprising:
detecting an operation on a second operation element after a set time has elapsed from a detection of an operation on a first operation element;
detecting a number of an operation element that is in ongoing operation at a timing when the operation on the second operation element is detected; and
controlling whether or not to advance a syllable to be sounded from a first syllable to a second syllable, which is a next syllable, based only on the number of the operation element that is in ongoing operation.
